(19) United States
(12) Patent Application Publication
(10) Pub. No.: US 2006/0249257 A1
(43) Pub. Date: Nov. 9, 2006

(54) Device for applying and heat-shrinking plastics labels, and process for applying said labels

(76) Inventor: Enrico Ghini, Cassino (FR) (IT)

Correspondence Address: YOUNG & THOMPSON, 745 SOUTH 23RD STREET, 2ND FLOOR, ARLINGTON, VA, 22202, US

(21) Appl. No.: 10/550,538

(22) PCT Filed: Feb. 20, 2004
(86) PCT No.: PCT/IT04/00076

§ 371 Date: May 24, 2006

(30) Foreign Application Priority Data
Mar. 24, 2003 (IT) RM2003 A 000128

(51) Int. Cl. B29C 65/00

(52) U.S. Cl. 156/443

(57) ABSTRACT

A device (1) for applying and heat-shrinking plastics labels includes a central body (2) and an outer body (3), coaxially movable one within the other one by the action of an injector element (14), positioned in such a way to realise an interspace (20) between the bodies, and shaped in such a way to receive a label (19) to be applied, and to position the same about the outer surface of the same container (18). The device includes a device (16) for introducing hot air into the interspace (20), so as to realise heat-shrinking of the label (19), and a device (4) to bring the outer body (3) back in the rest position, after having stopped the action on the injector element (14). Also described is a process for applying the labels.

The present invention relates to a device for applying and heat-shrinking plastics labels, and to a process for applying said labels.

More specifically, the invention concerns a device of the above kind allowing to apply and heat-shrink labels by a single step.

As it is well known, labelling of container for alimentary products and are kind of products can be realised employing labels comprised of a plastic film, mainly a printed film, having the property of shrinking by the action of heat, and usually known as heat-shrinkable film.

Plastic film is thin, generally between 25 and 5 micron and can be obtained starting from different polymers. Mainly, said film is comprised of PVC, PET and OPS. Said labels are realised folding and welding (or gluing) a film band in such a way to obtain a tubular elements thus joining the two edges of the film band according to the generatrix of the thus obtained cylinder.

Tubular element is flattened and wound on reels, destined to feed machines applying labels comprised of said material, by transverse cutting of portions of determined length. In any case, realisation of labels and their feeding at the apparatus for applying to the container are not subject matter of the present patent application, and will not be described in greater detail in the following.

This kind of label is defined in this specific field as “Shrink Sleeve”, the shrinking properties of which being activated y exposition to the heat.

At present, techniques for applying Shrink Sleeves, provide three main steps of the process, said steps being distinct and in succession, namely:
feeding from a reel and pitch cut of the tubular element;
application on the container of the Shrink Sleeve thus obtained;
exposition to the heat to obtain heat-shrinking of the label and thus the adhesion to the container.

At present, the last step is realised by different systems, but in any case, always after the application of the label, and by absolutely different and separated devices with respect to those employed for application of the Shrink Sleeve on the container.

To this end, it is particularly used a heated air circulation and/or steam tunnel, heated air jets, created by electric fans with thermo-resistances, impinging on the container during its passages.

In view of the above, it is well evident that it necessary a solution as the one suggested according to the present invention, allowing to carry out at the same time the application-positioning and heat-shrinking steps of the label on the container.

These and other results are obtained, according to the present invention, suggesting a device allowing to carry out at the same time the application/positioning and heat-shrinking operations on the label.

It is therefore specific object of the present invention a device for applying and heat-shrinking plastics labels comprising a central body and an outer body, coaxially movable one within the other one by the action of an injector element, positioned in such a way to realise an interspace between said bodies, and shaped in such a way to receive a label to be applied, and to position the same about the outer surface of the same container, being provided means for introducing hot air into said interspace, so as to realise heat-shrinking of the label, being further provided means to bring the outer body back in the rest position, after having stopped the action on said injector element.

In an embodiment of the device according to the invention, it can be provided a base element, on which said central body is integrally coupled.

Particularly, according to the invention, said central body has an essentially cylindrical shape, with an upper outward tapering, and innerly hollow, with the upper portion closed.

Furthermore, said hollow central body can provide a series of rectangular openings, particularly four openings, radially provided on the outer surface of the cylindrical body, in its conical part, in correspondence of the upper edge.

Further, grooves are obtained on the surface of the central body, preferably four grooves, said grooves being longitudinally oriented and having such a depth to cross the thickness of the wall.

Still according to the invention, said outer body is comprised of a substantially cylindrical tube having inner diameter larger than the outer diameter of said central body, said tube being coaxially mounted on the same central body, being it provided a thickening on the basis of the tube, realising a sealing ring.

Furthermore, according to the invention, said tube comprising the outer body has a plurality of appendices on the inner wall, preferably four appendices, in a number corresponding to the number of said grooves of the central body, entering within the grooves and projecting within the inner wall of the central body.

Always according to the invention, said means to bring the outer body in the rest position are comprised of a spring.

Furthermore, according to the invention, said base has a parallelepiped shape with a through hole realised according to the vertical axis of the base-central body assembly and with dimensions sufficient to allow the passage of the injector body.

Particularly, coupling between base and central body can occur by welding, screwing and like.

Still according to the invention, said injector element is comprised of an outer substantially cylindrical tube, that can be easily inserted within the central body, said injector element being provided with a vertical stroke, by actuating means, e.g. a pneumatic cylinder.

Always according to the invention, said injector element is coupled to a flow generated by a heat source, such as an electric fan with heat-resistances, by a telescopic tube or by a steam conduct.

Furthermore, according to the invention, said device can be provided on a carrousel rotating on a vertical or horizontal plane, on a band on a flat links chain, a mechanical system, etc.

According to the invention, there can be provided a plurality of devices, acting contemporaneously and provided according to a configuration suitable to the manufacturing line.

The invention further concerns a process for applying said labels comprising the steps of:
supplying the labels in correspondence of the interspace between the central body and the outer body;
bringing the device with the vertical axis of the container to be labelled by transportation systems;
maintaining the device aligned with the container and the injector element during the label application and heat-shrinking step;
operating the actuator realising the vertical stroke of the injector element, inserting the same within the device and moving the outer body, in such a way to bring also the label in position about the container;
actuating the heat source connected to the injector element, thus heat-shrinking the label on the container;
removing the outer body about the labelled container.

The present invention will be now described, for illustrative but not limitative purposes, according to its preferred embodiments, with particular reference to the figures of the enclosed drawings, wherein:

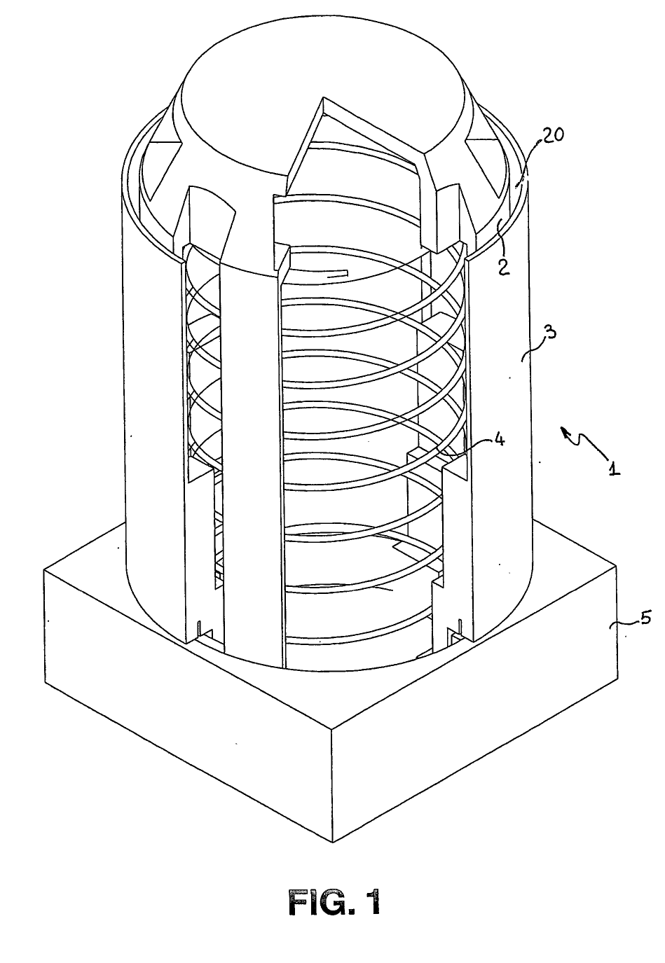

FIG. 1 is a perspective view of an embodiment of the device according to the invention;

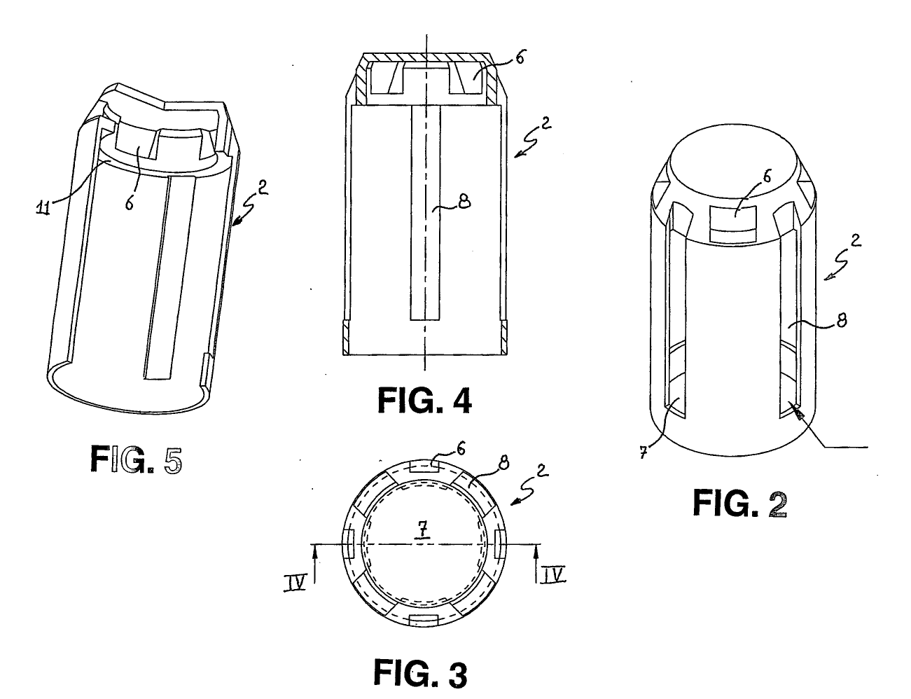

FIG. 2 is a perspective view of the central body of the device of FIG. 1;

FIG. 3 is a top view of the body of FIG. 2;

FIG. 4 is a section view taken along line IV-IV of FIG. 3;

FIG. 5 is a partial view of the body of FIG. 2;

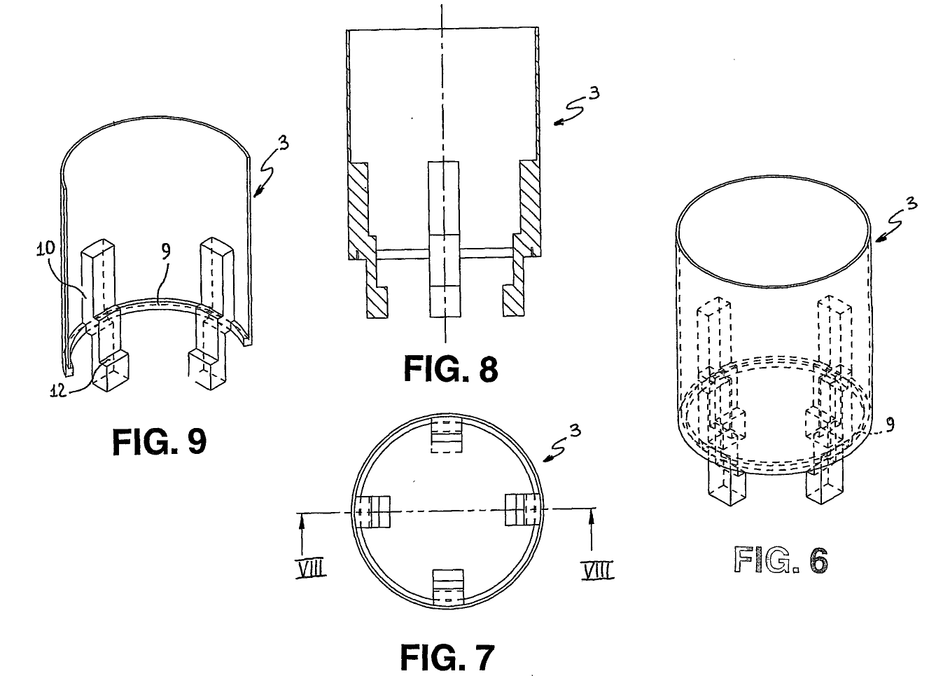

FIG. 6 is a perspective view of the outer body of device of FIG. 1;

FIG. 7 is a top view of the body of FIG. 6;

FIG. 8 is a section view taken along line VIII-VIII of FIG. 7;

FIG. 9 is a partial view of the body of FIG. 6;

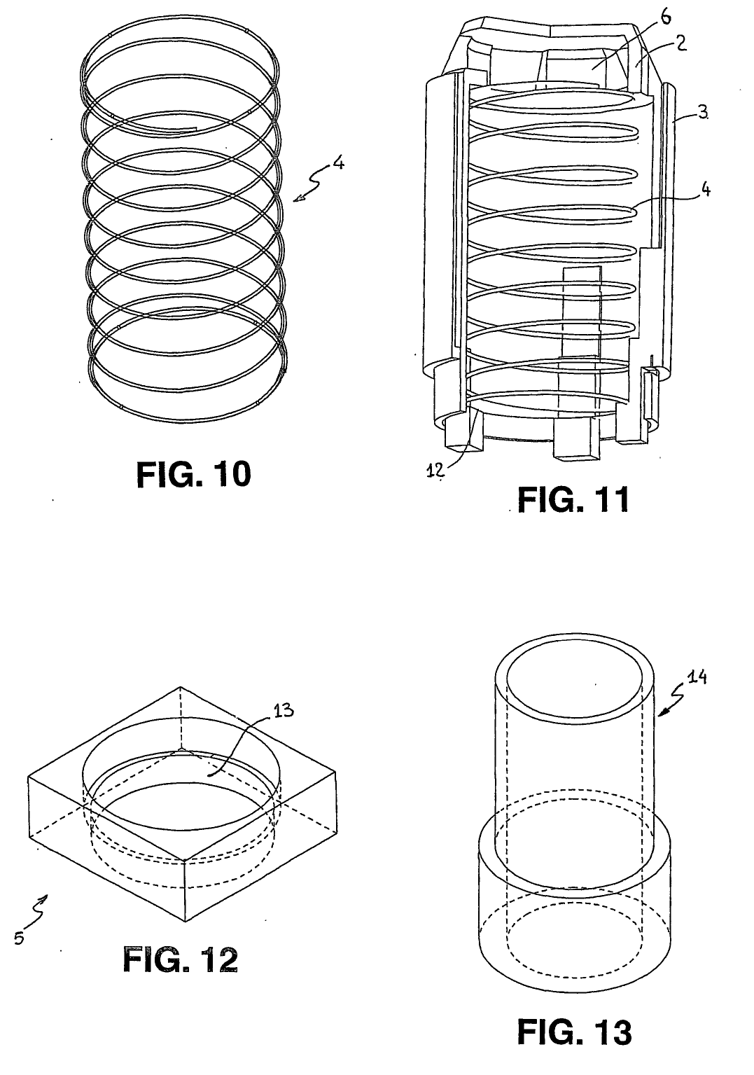

FIG. 10 is a perspective view of the spring of the device of FIG. 1;

FIG. 11 is a partially broken away, perspective view of the inner and outer bodies and of the spring, assembled each other;

FIG. 12 is a perspective view of the base of the device according to the invention;

FIG. 13 is a perspective view of the injector of the device according to the invention;

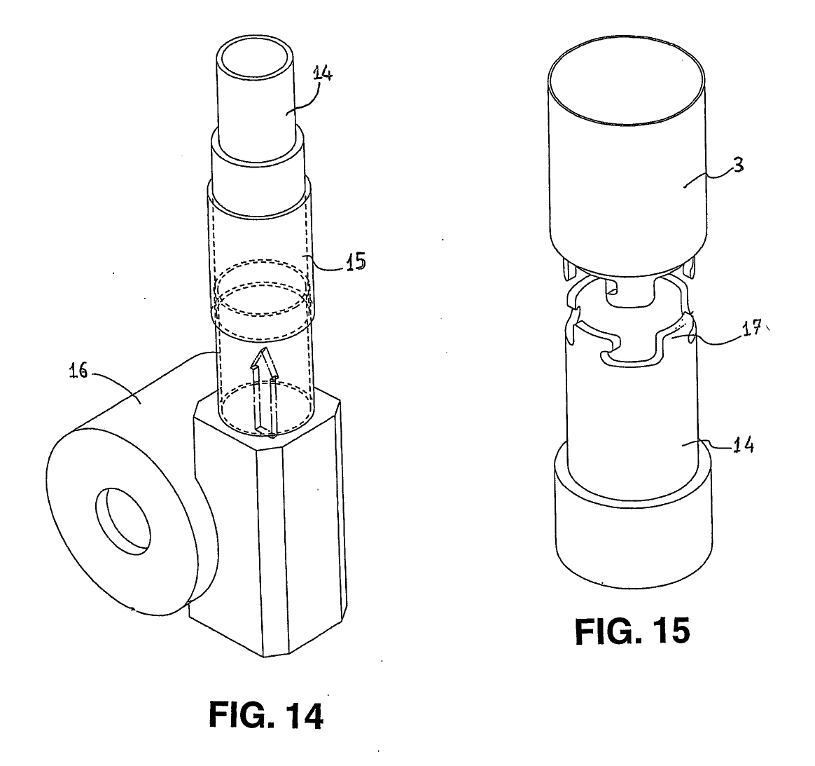

FIG. 14 is a perspective view of the injector of FIG. 13 applied to a thermo fan by a telescopic tube;

FIG. 15 is an exploded perspective view of a different embodiment of the injector coupled with the outer body;

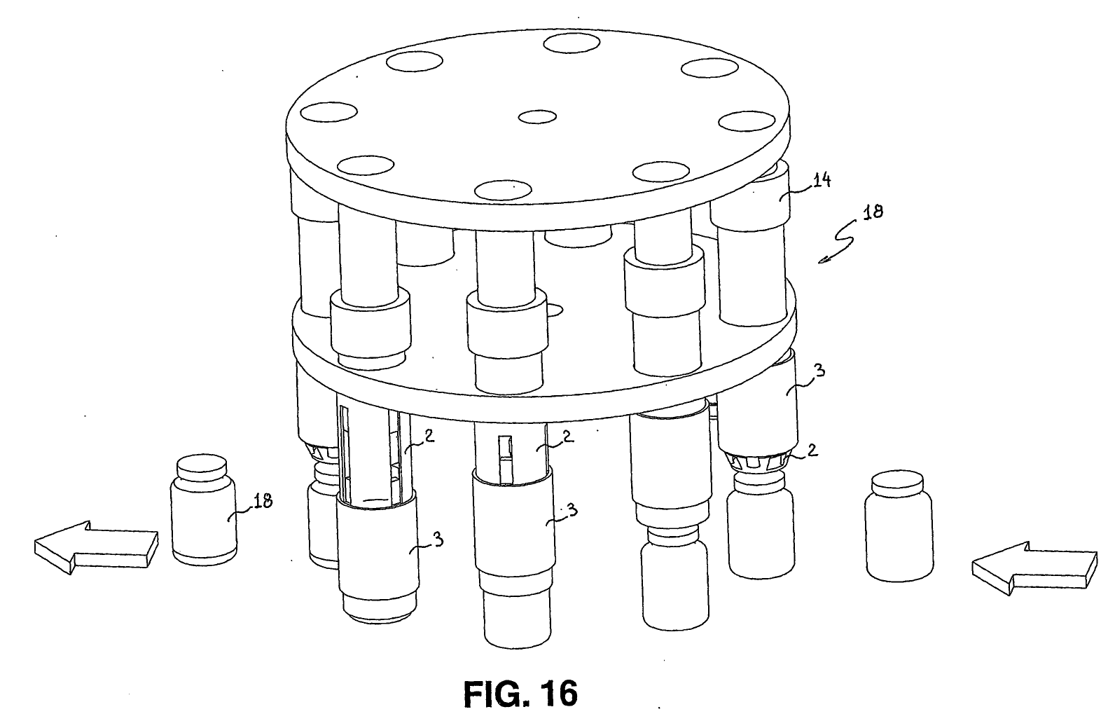

FIG. 16 is a perspective view of a machine providing the device according to the invention;

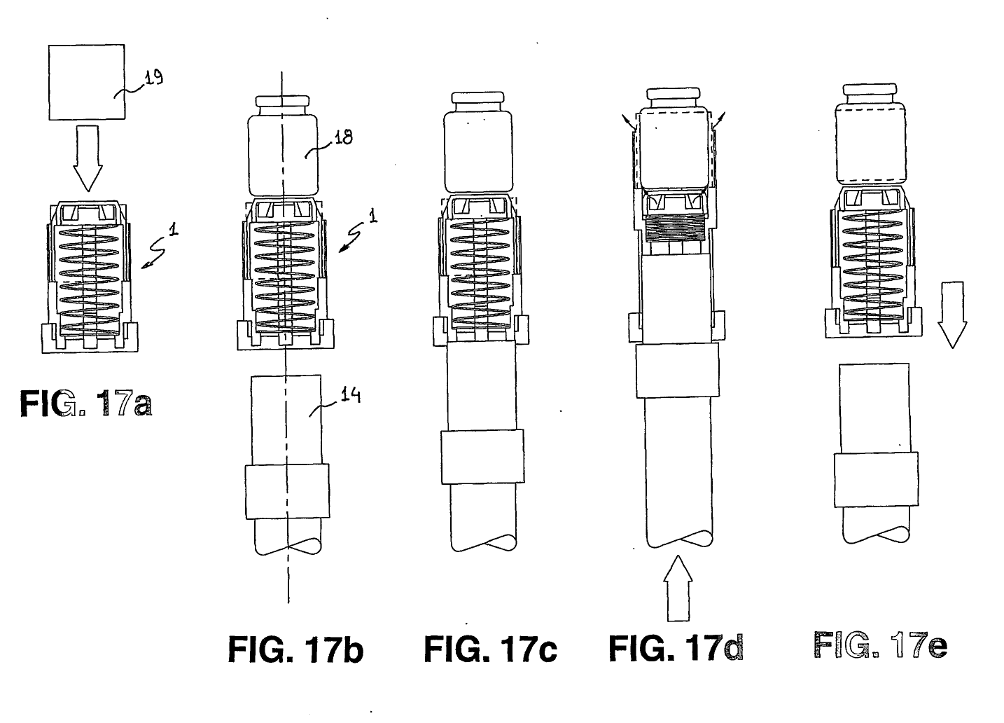

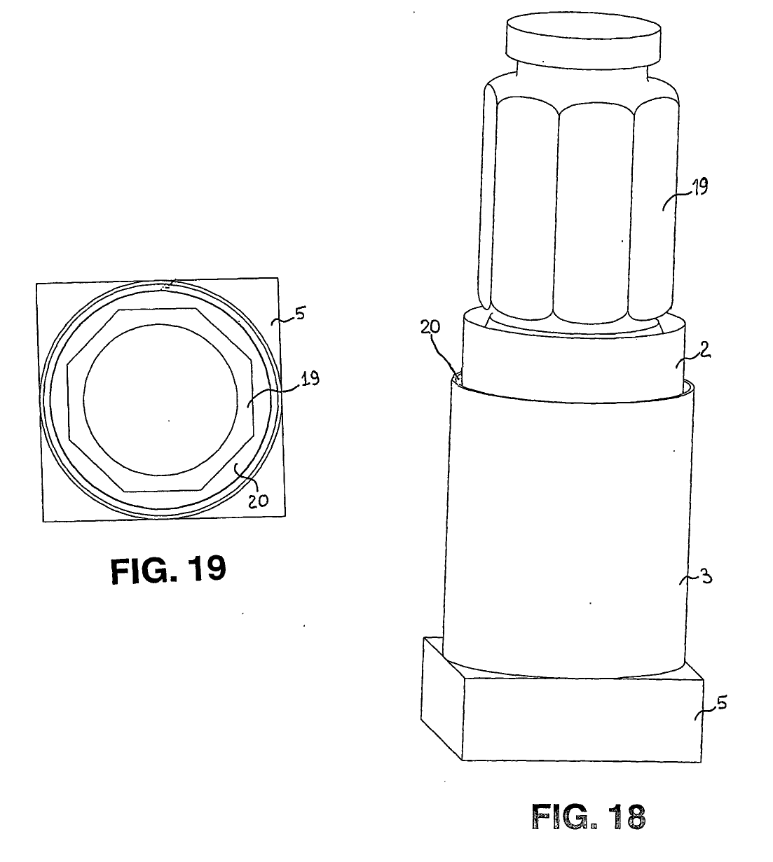

FIGS. 17a-17e show the positioning sequence of the label by the device according to the invention, the label being positioned from the bottom;

FIG. 18 is a perspective view of the device according to the invention with a different kind of container; and

FIG. 19 is a top view of the device of FIG. 18.

In the following an embodiment of the device according to the invention will be described, studied to apply the label from the bottom, particularly on a pot, e.g. containing yoghurt and like, but it is well evident that the same solution can be used also to apply the label from the top, and on a different kind of container.

Further, it must be underlined that the motion system of the device according to the invention, to bring the same in a position to apply the label can vary in function of the manufacturing line, of the kind of container on which the label can be applied, and of the product contained within the same.

Making reference to the figures of the enclosed drawings, it will be described the application of the device according to the invention on a cylindrical container, e.g. those used for yoghurt, having a diameter of about 50 mm and a height of 60 mm.

As it can be noted observing the figures of the enclosed drawings, the device according to the invention provides a group of assembled parts, that will be indicated in the following, the above group being indicated by the reference number 1, and named as shuttle. Substantially, shuttle 1 is comprised of four elements, namely a central body 2, an outer body 3, a spring 4 and a base 5.

Observing now FIGS. 2-5, it can be noted that said central body 2 has an essentially cylindrical shape, tapered at the top, with a slight conicity. Inner portion of said body 2 is hollow and the upper base closed.

A plurality of rectangular section openings or windows 6, four in the embodiment shown, are provided radially o the outer surface of the cylinder 2, in the conical part, close to the upper edge. Said openings communicate the inner cavity 7 of the central body 2 with the outside.

Further, grooves 8 (four in the present embodiment) are realised on the surface of the central body 2, said grooves being provided vertically and having a depth crossing the thickness of the wall of the central body 2. said grooves 8 extend from about 10 mm above the lower edge of the central body 2 up to an imaginary plane perpendicular to the axis of the central body and quasi passing through the base of said windows 6.

Observing now FIGS. 6-9, it is shown the outer body 3, comprised, in the present embodiment, by a substantially cylindrical tube, having an inner diameter 2-3 mm bigger than the outer diameter of said central body 2, and coaxially mounted with respect to the same central body 2.

Positioning between central body 2 and outer body 2 is guaranteed by a thickening 9 provided on the base of the body 3, realising a sealing ring, increasing the inner diameter of the outer body 3 contacting the central body 2 for a height of 3-5 mm. In any case, dimension ratio is such to allow the easy sliding of the outer body 3 with respect to the central body 2.

Said outer body 3 has, on the inner wall, a plurality of appendices 10, in this case four, a number corresponding to the number of grooves 8 of the central body 2.

Said appendices 10 enter into said grooves 8, projecting inside the inner wall of the central body 2.

In FIG. 10, it is shown the spring 4 of the device 1 or shuttle according to the invention. Said spring 4 is a standard cylindrical compression spring mounted inside the central body 2.

When the shuttle 1 is assembled, spring 4 is slightly compressed: the upper plane of the spring 4 acts against an annular edge 11 obtained within the central body 2, while the lower plane of the spring 4 rests on teeth 12 obtained on the lower end of the appendices 10 (see FIG. 9 and FIG. 11).

Observing now FIG. 12, it is shown the base 5 of the shuttle 1 according to the invention, having a parallelepiped shape, and on the upper face of which the central body 2 is mounted. Said base 5 has a through hole 13, realised according to the vertical axis of the base 5-central body 2 assembly, and with such dimensions to allow the passage of the injector (that will be described in the following).

It will be realised an integral coupling by welding between central body 2 and base 5 of he shuttle 1, said coupling being an essential feature for the working of the device according to the invention.

Once assembled, four elements of the shuttle 1, as shown in FIG. 1, it is obtained a device with an interspace between central body 2 and outer body 3, and thrust of spring 4 maintains the outer body 3 in position, pushing it against the base 5.

To apply the label, the device according to the invention needs an injector element, separated with respect to the shuttle 1, and that will be described in greater detail in the following.

Particularly (see FIG. 13), injector element 14 is comprised of an outer substantially cylindrical tube, to be easily introduced within the shuttle 1, particularly within the central body 2.

Injector element 14 makes a vertical stroke, e.g. obtained by a pneumatic cylinder (not shown), or other actuating system, that is not part of the present invention, and thus will be not described in greater detail in the following, and will have to be coupled with the flow generated by a heat source (not shown as well).

For example, said injector element can be connected, by a telescopic tube 15, with an electric fan 16, provided with thermal resistances, or with a steam condotto.

As already said, base 5 and spring 4 are not essential elements for the device 1 according to the invention, and they could be replaced by equivalent solutions, always to be considered included within the scope of the present invention.

Since said spring 4 is provided in order to make sure that the outer body 3 goes back to the original position after the lifting, the same function could be obtained coupling the outer body 3 with jaws 17, that could be realised on the injector element 14 (see the solution of FIG. 15).

Furthermore, said base 4 is only an element used to stabilise the device 1 according to the invention. Said base becomes useless if the central body 3 is fixed to a mechanical motion system, such as a rotating carrousel of the kind illustrated in FIG. 16.

It must be once again underlined that the feeding system shown in FIG. 16, providing a rotating carrousel 18, to which the pots 19 on which the Shrink Sleeve labels are fed, is not part of the invention and can be modified in function of the use of the device according to the invention.

Observing also FIG. 17, apparatus cutting the Shrink sleeve labels, differently with respect to the known applications, applies said labels on the shuttle, particularly within the interspace between central body and the outer body (FIG. 11, position 1).

Coming now to observe FIG. 17a-1e, it can be observed sequence of positioning of the label from the bottom by the device according to the invention.

Apparatus feeding and cutting the Shrink Sleeve labels from the reel is not part of the invention.

After having received the Shrink Sleeve 19 (FIG. 17a), shuttle 1 is aligned with respect to the vertical axis of the container 18 to be labelled (FIG. 17b) by transportation systems (not shown), said systems not being an essential part of the device according to the invention.

As can be easily sensed, in fact, shuttle 1 could be transported by a belt or flat links chain (similar to those employed for transportation of the bottles in packaging lines), or it can be coupled with a mechanical system, for example a carrousel 18 rotating on the vertical or horizontal plane (as the one shown in FIG. 16).

In any case, shuttle 1, in a fixed position or moving in step with the container 19, should be maintained aligned with the container 19 and the injector element 14 during the application and thermo shrinking phase of the Shrink Sleeve label (FIGS. 17b-17e).

Operating the actuator (not shown), causing the vertical stroke of the injector element 14, it enters into the shuttle 1 from the hole 13 of the base 5, lifting the outer body 3, pushing on the lower faces of the appendices 12, integral with the same body 3 and compressing the spring 4 (FIG. 17c).

By this movement, it is obtained also the lifting of the Shrink Sleeve label, the lower edge of which rests on the appendices 12 of the outer body 3, putting it about the container 19 standing above. Container 19 will be now wound by the Shrink Sleeve label and inserted within the outer body 3.

Now, the heat source connected to the injector element 14 is activated, e.g. thermo fan 16, so that hot air flow passes through the injector element 14, enters within the central body, coming out from the windows 6. Ring 9 on the basis of the outer body 3, adhering to the outer surface of the central body 2, prevents the air flow from dispersing downward, thus optimising its exploitation.

Hot air sent must thus flow upward through the interspace between outer body 3 and container 19, heating the Shrink Sleeve label and thermo shrinking the same.

Once completed the shrinking, injector element 14 goes back under the lower plane of the base 5 of the shuttle 1, and along the element 14 also the outer body 3 moves, due to the action of the spring 4. in this way, also the container 19, provided with the label, is disengaged.

FIGS. 8 and 19 have been enclosed to demonstrate that the solution according to the present invention can be used without any problem with containers 19 having different shapes with respect to the circular shape, e.g. the octagonal section shown in the two figures. What is important is the interspace 20 between inner body 2 and container 19, to be able to carry out the above described heat-shrinking.

Device described can be realised to work also on not cylindrical containers, by the suitable realisation of the various elements with shapes similar to those of the container to be subjected to the treatment.

In any case, frusto conical containers or polygonal section containers (for example octagonal section) can be subjected to treatment employing shuttles with a cylindrical outer body, since the volume of the interspace within which heat-shrinking occurs is in any case very small.

From the above, it can be understood that the device according to the invention allows to obtain a better efficiency and rapidity of execution with respect to the results that could be obtained, for example, by employing a hot air circulation tunnel, where dispersion of thermal energy not directly conveyed nor limited to the Shrink Sleeve label is much bigger.

This result is mainly obtained in view of the reduced volume to be heated about the container, said volume being limited to the outer body 3, within which the container is inserted, and realising a structure that can be indicated as heat-shrinking bell.

The present invention has been described for illustrative but not limitative purposes, according to its preferred embodiments, but it is to be understood that modifications and/or changes can be introduced by those skilled in the art without departing from the relevant scope as defined in the enclosed claims.

1. Device for applying and heat-shrinking plastics labels, characterised in that it comprises a central body and an outer body, coaxially movable one within the other one by the action of an injector element, positioned in such a way to realise an interspace between said bodies, and shaped in such a way to receive a label to be applied, and to position the same about the outer surface of the same container, being provided means for introducing hot air into said interspace, so as to realise heat-shrinking of the label, being further provided means to bring the outer body back in the rest position, after having stopped the action on said injector element.

2. Device according to claim 1, characterised in that it is provided a base element, on which said central body is integrally coupled.

3. Device according to claim 1, characterised in that said central body has an essentially cylindrical shape, with an upper outward tapering, and innerly hollow, with the upper portion closed.

4. Device according to claim 3, characterised in that said hollow central body provides a series of rectangular openings, particularly four openings, radially provided on the outer surface of the cylindrical body, in its conical part, in correspondence of the upper edge.

5. Device according to claim 3, characterised in that grooves are obtained on the surface of the central body, preferably four grooves, said grooves being longitudinally oriented and having such a depth to cross the thickness of the wall.

6. Device according to claim 1, characterised in that said outer body is comprised of a substantially cylindrical tube having inner diameter larger than the outer diameter of said central body, said tube being coaxially mounted on the same central body, being it provided a thickening on the basis of the tube, realising a sealing ring.

7. Device according to claim 6, characterised in that said tube comprising the outer body has a plurality of appendices on the inner wall, preferably four appendices, in a number corresponding to the number of said grooves of the central body, entering within the grooves and projecting within the inner wall of the central body.

8. Device according to claim 1, characterised in that said means to bring the outer body in the rest position are comprised of a spring.

9. Device according to claim 2, characterised in that said base has a parallelepiped shape with a through hole realised according to the vertical axis of the base-central body assembly and with dimensions sufficient to allow the passage of the injector body.

10. Device according to claim 9, characterised in that coupling between base and central body is obtained by welding, screwing and like.

11. Device according to claim 1, characterised in that said injector element is comprised of an outer substantially cylindrical tube, that can be easily inserted within the central body.

12. Device according to claim 11, characterised in that said injector element has vertical stroke, obtained by actuating means, e.g. a pneumatic cylinder.

13. Device according to claim 11, characterised in that said injector element is coupled to a flow generated by a heat source, such as an electric fan with heat-resistances, by a telescopic tube or by a steam conduct.

14. Device according to claim 1, characterised in that said device is provided on a carrousel rotating on a vertical or horizontal plane, on a band on a flat links chain, a mechanical system, etc.

15. Device according to claim 1, characterised in that there is provided a plurality of devices, acting contemporaneously and provided according to a configuration suitable to the manufacturing line.

16. Process for applying said labels, characterised in that it comprises the steps of:
supplying the labels in correspondence of the interspace between the central body and the outer body;
bringing the device with the vertical axis of the container to be labelled by transportation systems;
maintaining the device aligned with the container and the injector element during the label application and heat-shrinking step;
operating the actuator realising the vertical stroke of the injector element, inserting the same within the device and moving the outer body, in such a way to bring also the label in position about the container;
actuating the heat source connected to the injector element, thus heat-shrinking the label on the container;
removing the outer body about the labelled container.

17. Device according to claim 5, characterised in that grooves are obtained on the surface of the central body, preferably four grooves, said grooves being longitudinally oriented and having such a depth to cross the thickness of the wall.

18. Device according to claim 2, characterised in that said outer body is comprised of a substantially cylindrical tube having inner diameter larger than the outer diameter of said central body, said tube being coaxially mounted on the same central body, being it provided a thickening on the basis of the tube, realising a sealing ring.

19. Device according to claim 3, characterised in that said outer body is comprised of a substantially cylindrical tube having inner diameter larger than the outer diameter of said central body, said tube being coaxially mounted on the same central body, being it provided a thickening on the basis of the tube, realising a sealing ring.

20. Device according to claim 4, characterised in that said outer body is comprised of a substantially cylindrical tube having inner diameter larger than the outer diameter of said central body, said tube being coaxially mounted on the same central body, being it provided a thickening on the basis of the tube, realising a sealing ring.
